(19) United States
(12) Patent Application Publication
(10) Pub. No.: US 2025/0267668 A1
(43) Pub. Date: Aug. 21, 2025

(54) PRECODING AND SIGNALING FOR UL TRANSMISSIONS VIA THREE TRANSMIT ANTENNA PORTS

(71) Applicant: Apple Inc., Cupertino, CA (US)

(72) Inventors: Sigen YE, San Diego, CA (US); Haitong SUN, Saratoga, CA (US); Wei ZENG, Saratoga, CA (US); Dan WU, Beijing (CN); Dawei ZHANG, Saratoga, CA (US); Oghenekome OTERI, San Diego, CA (US); Weidong YANG, San Diego, CA (US); Hong HE, San Jose, CA (US)

(21) Appl. No.: 19/053,318

(22) Filed: Feb. 13, 2025

Related U.S. Application Data
(60) Provisional application No. 63/554,869, filed on Feb. 16, 2024.

(51) Int. Cl. H04W 72/21; H04B 7/0417

(52) U.S. Cl. CPC H04W 72/21; H04B 7/0417

(57) ABSTRACT

The techniques described herein may include solutions for fully coherent, partially coherent, and non-coherent precoders for uplink (UL) transmissions using three antenna or antenna ports. Many examples of precoding matrices, precoding vectors, and phase shifts are described, including factors, conditions, and calculations that may be applicable depending on a given scenario or in a given implementation.

### CROSS REFERENCE TO RELATED APPLICATIONS

This application claims the benefit of U.S. Provisional Application No. 63/554,869, filed Feb. 16, 2024, the entire disclosure of which is herein incorporated by reference for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. This may include techniques for precoding wireless signals sent between UEs and base stations.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview of precoding and signaling for uplink (UL) transmissions via three transmit antenna ports according to one or more implementations described herein.

FIG. 2 is a diagram of an example network according to one or more implementations described herein.

FIG. 3 is a diagram of an example of a process for precoding and signaling for UL transmissions via three transmit antenna ports according to one or more implementations described herein.

FIG. 4 is a diagram of an example of a user equipment (UE) according to one or more implementations described herein.

FIG. 5 is a diagram of an example of a UE according to one or more implementations described herein.

FIG. 6 is a diagram of an example of a UE according to one or more implementations described herein.

FIG. 7 is a diagram of an example of a process for precoding and signaling for UL transmissions via three transmit antenna ports according to one or more implementations described herein.

FIG. 8 is a diagram of an example of a process for precoding and signaling for UL transmissions via three transmit antenna ports according to one or more implementations described herein.

FIG. 9 is a diagram of an example of components of a device according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include a UE providing base stations with capability information, the network determining how to configure the UE based on the capability information, the network providing the UE with configuration information, and the UE and base station communicating further in accordance with the configuration information.

Precoding may refer to a signaling technique to support multi-stream or multi-layer transmissions via multiple antenna ports. An antenna port, as described herein, may include an antenna, an antenna port, or another type of functional antenna feature. A UE and a base station may each include multiple antenna ports, such that multiple-input multiple-output (MIMO) transmissions are possible. In such a scenario, precoding uplink (UL) transmissions may include the UE using the multiple antenna ports to transmit multiple data streams, with independent and appropriate weights, such that greater throughput may be achieved by the multiple antenna ports of the base station. Antenna coherency, physical position, signal noise, and other antenna configurations and conditions may affect the timing, phase, transmission power, etc., of the signal transmitted by each antenna port.

Precoding may include the transmitter signal processing used to affect the received signal's maximization at specific receivers and antennas, while reducing the interference to all other receivers and receiving antennas. Precoding may use channel state information (CSI) at the transmitter to improve performance and increase spectral efficiency. Precoding may be used to implement the superposition of multiple beams, including several different data streams of information for spatial multiplexing.

Precoding and beamforming may be used together in telecommunication networks. Precoding may refer to a software implementation of communication theory, while beamforming may refer to a hardware implementation and the antennas involved. Precoding may generally refer to the transmitter side, while beamforming may be applied to both transmitters and receivers. Precoding may include the individual control of amplitudes and phases of signals sent from transmit antennas, and when precoding is implemented with beamforming, precoding may better focus energy toward the intended receiver. Precoding may assume that channel state information (CSI) is known at the transmitter. Precoding may begin with channel sounding, which may involve sending a coded message to a receiver and receiving individual CSIs to the transmitter. The CSIs may be used to set a precoding (spatial mapping) matrix for subsequent data transmissions.

A codebook may include a matrix or precoding matrix of value elements that may be used to transform information that maps to antenna ports in a MIMO scenario. A codebook-based transmission may involve a techniques where the UE determines a transmission strategy using a predefined set of precoding vectors, known as a codebook. A codebook-based transmission may rely on an indicated sounding reference signal (SRS) resource to determine an appropriate codebook and transmit precoding matrix indicator (TPMI) values to indicate which precoder to use from the codebook for the transmission. One or more of the techniques described herein may include solutions for precoding and signaling for UL transmissions via three transmit antennal elements (which may be referred to as a 3-Tx transmission).

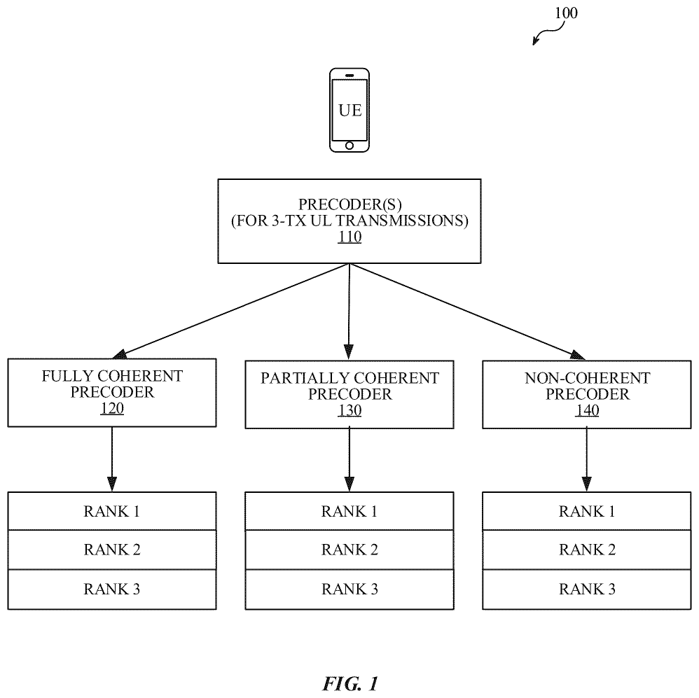

FIG. 1 is a diagram of an example of an overview 100 of precoding and signaling for uplink (UL) transmissions via three transmit antenna ports according to one or more implementations described herein. As shown, overview 100 may include a UE with precoders 110 that may include one or more of a fully coherent precoders 120, partially coherent precoders 130, and/or a non-coherent precoders 140. Fully coherent precoders 120 may be implemented by the UE operating in a fully coherent mode. Partially coherent precoders 130 may be implemented by the UE operating in a partially coherent mode, and non-coherent precoders 140 may be implemented by the UE operating in a non-coherent mode. An antenna, as described herein, may refer to an antenna or an antenna port of a UE.

In a fully coherent mode, the UE may control the maximum difference between the relative power and phase errors between different antenna ports of UE 210 within a certain time window (e.g. 20 ms). This ensures the effectiveness of the precoder for PUSCH. A fully coherent precoder, as described herein, may be designed for a 3-Tx linear antenna array (e.g., a 1×3 array) with equal spacing. In a partially coherent mode, the UE may maintain coherency over some, but not all, antennas or antenna ports. For instance, in a 3-Tx linear antenna array scenario comprising three antenna ports, two of the antenna ports may operate as though coherent with respect to one another, while the third antenna port may operate independently. In a non-coherent mode, all antennas or antenna ports may operate independently.

As shown, each of fully coherent precoders 120, partially coherent precoders 130, and non-coherent precoders 140 may include rank 1 precoding, rank 2 precoding, and rank 3 precoding. A rank may correspond to a number of vectors of a precoding matrix that are linearly independent or orthogonal to the other vectors of the precoding matrix. Linear independence may refer to a lack of correlation between or among vectors. For example, vectors oriented in different spatial directions may be linearly independent of one another. By contrast, vectors oriented in the same spatial direction, or opposite spatial directions, may not be linearly independent of one another. A rank 1 precoder may have 1 linearly independent precoding vector; a rank 2 precoder may have 2 linearly independent precoding vectors, and a rank 3 precoder may have 3 linearly independent precoding vectors. Accordingly, different precoder matrixes may be used for precoders of different ranks. A rank may be indicated by a rank indicator (RI) and may be associated with a precoding matrix that may be indicated by a precoding matrix indicator (PMI) and associated codebook(s). These and other features and examples are described in additional detail with reference to remaining Figures.

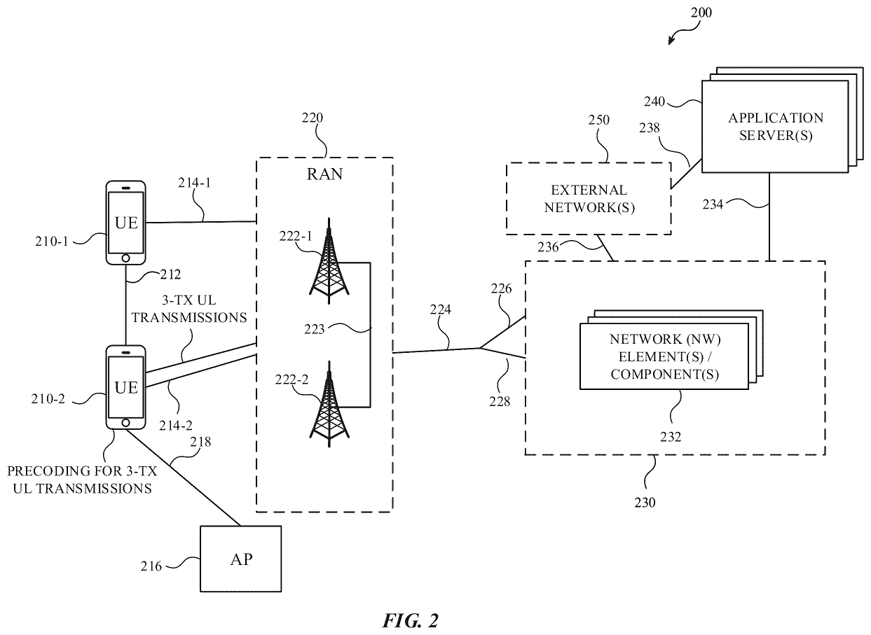

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be

communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network clements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

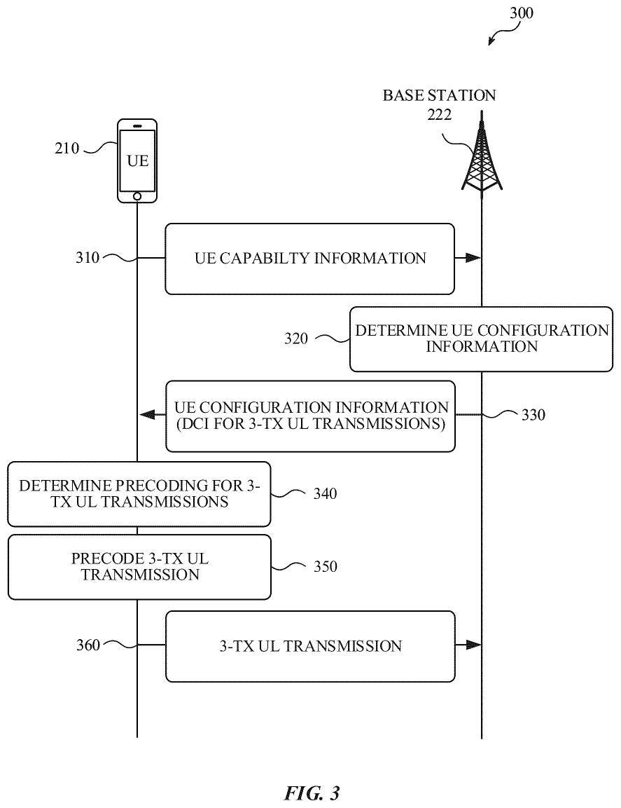

FIG. 3 is a diagram of an example of a process 300 for precoding and signaling for UL transmissions via three transmit antenna ports according to one or more implementations described herein. Process 300 may be implemented by UE 210 and base station 222. In some implementations, some or all of process 300 may be performed by one or more other systems or devices, including one or more of the devices of FIG. 2. Additionally, process 300 may include one or more fewer, additional, differently ordered and/or arranged operations than those shown in FIG. 3. In some implementations, some or all of the operations of process 300 may be performed independently, successively, simultaneously, etc., of one or more of the other operations of process 300. As such, the techniques described herein are not limited to the number, sequence, arrangement, timing, etc., of the operations depicted in FIG. 3.

As shown, UE 210 may send UE capability information to base station 222 (at 310). The UE capability information may indicate the ability of UE 210 to send, receive, and support one or more types of communications, information, processes, and/or services. In some implementations, the UE capability information may include an indication of an ability, requirement, or preference for UE 210 to communicate in the UL direction using 3 antennas, antenna ports, and/or antenna ports. Additionally, or alternatively, the UE capability information may include an indication of an ability, requirement, or preference for UE 210 to communicate in the UL direction in a fully coherent, partially coherent, and/or non-coherent manner.

Base station 222 may determine UE configuration information for UE 210 (at 320). Base station 222 may determine the UE configuration information based on the UE capability information. The UE configuration information may include a wide variety of information and types of information, which may cause UE 210 to operate in one form or another. The UE configuration information may include DCI, RRC information, and more, including information for 3-Tx UL transmissions. The RRC configuration may be semi-static, while the DCI configuration may include dynamic scheduling information. The RRC information may include a codebook configuration for 3Tx, and the DCI may include the exact precoder to be used for a PUSCH via, for example, a TPMI field.

In some implementations, the UE configuration information may be sent as DCI according to DCI format 0_1 or another DCI format. The UE configuration information may include an indication of a codebook and/or precoders that may be used by UE 210 for UL communications. In some implementations, the UE configuration information may include one or more data sets of the matrixes, vectors, and/or precoding information described herein.

Base station 222 may send the UE configuration to UE 210 (at 330). The UE configuration information may include a codebook to enable UE 210 to communicate with base station 222. The codebook may include fully coherent precoders, partially coherent precoders, non-coherent precoders, and/or any combination thereof. This may include the codebook including only fully coherent precoders, only partially coherent precoders, or only non-coherent precoders. The UE configuration information may include a rank indicator (RI) and TPMI. These information elements may inform UE 210 about the rank and precoder to be used for 3-Tx UL transmissions. The RRC configuration may be semi-static, while the DCI configuration may include dynamic scheduling information. The RRC information may include a codebook configuration for 3Tx, and the DCI may include the exact precoder to be used for a PUSCH via, for example, a TPMI field.

In some implementations, the DCI may include a joint RI/TPMI indication, where precoding matrices for each rank (i.e., rank 1, rank 2, and rank 3) may be indicated with a unique index value. In some implementations, the DCI may indicate an RI and TPMI separately. In such a scenario, each precoder may be provided with a unique index within precoders of the same rank. For example, the DCI may include an indication of a rank and a unique index value corresponding to a precoder (of that rank). Additionally, the DCI may indicate the RI and TPMI separately (e.g., using either two DCI fields or two sub-fields within the same DCI field. In such scenarios, the TPMI may refer to a precoder index of the precoders with the same rank (i.e., rank 1, rank 2, and rank 3).

In some implementations, RI and/or TPMI may be indicated separately for different antenna groups. For example, UE 210 may include 3 antennas (and/or antenna ports) that are arranged into 2 transmitting groups. A first group may include 2 antennas that are fully coherent with respect to one another. The second group may include 1 antenna that is non-coherent with respect to the 2 antennas of the first group. In such a scenario, UE 210 may be partially coherent overall, since the first group is fully coherent, and the second group is non-coherent.

In some implementations, an RI and TPMI indication may be accomplished by two TPMI indications (e.g., one for each group). In some scenarios, a codebook indicated by base station 222 may only consist of partially coherent precoders. Additionally, or alternatively, one TPMI indication may indicate one of the 6 fully coherent 2Tx UL precoders (described herein) if the antenna group is used or that the antenna group is not to be used. Another TPMI indication may be a single bit of DCI and indicate whether the second antenna group (e.g., the non-coherent antenna) is to be used. In other scenarios, the codebook indicated by base station 222 may only consist of non-coherent precoders. One TPMI indication may indicate one of the 3 non-coherent 2Tx UL precoders (described herein) if the antenna group is used or that the antenna group is not to be used. Another TPMI indication may be a single bit of DCI and indicate whether the second antenna group (e.g., the non-coherent antenna) is to be used. In yet other scenarios, the codebook indicated by base station 222 may include both partially coherent and non-coherent precoders. One TPMI indication may indicate one of the 9 fully coherent 2Tx UL precoders (described herein) if the antenna group is used or that the antenna group is not to be used. Another TPMI indicator may be a single bit of DCI and indicate whether the second antenna group (e.g., the non-coherent antenna) is to be used.

UE 210 may determine one or more precoding schemes for 3-Tx UL transmissions (at 340). UE 210 may determine this based, at least in part, on the UE configuration information from base station 222. In some implementations, UE 210 may determine one or more precoding for 3-Tx UL transmission without the UE configuration information from base station 222. In some implementations, this may include determining a coherency (e.g., fully coherent, partially coherent, and/or non-coherent) scheme for 3-Tx UL transmissions. Additionally, or alternatively, this may include determining matrixes, vectors, and other information for 3-Tx UL transmissions. UE 210 may implement the one or more precoding schemes by precoding a 3-Tx UL transmission (at 350) and sending the transmission to base station 222 (at 360). Additional examples and details of the information, operations, and communications described in FIG. 3 are described below with reference to the figures that follow.

In a full power mode regarding 3-Tx UL transmissions as described herein, for a codebook consisting of partially coherent precoders, or a codebook consisting of both partially coherent and non-coherent precoders, one or more fully coherent precoders may be added for rank 1. In some scenarios, fully coherent precoders for rank 2 and/or rank 3 may not be added since there may already be partially coherent precoders that use all 3 transmit antennas or antenna ports and provide full-power transmission. In other scenarios, for a codebook consisting of non-coherent precoders only, one or more fully coherent precoders may be added for rank 1 and/or rank 2. In such scenarios, fully coherent precoders may not be added for rank 3 since the non-coherent precoder(s) for rank 3 may already use all 3 transmit antennas or antenna ports and provide full-power transmission.

Additionally, or alternatively, in a full power mode regarding 3-Tx UL transmissions and antenna virtualization, a maximum of 2 or 4 SRS resources may be supported in an SRS resource set with a usage set to “codebook,” where each SRS resource may have 1, 2 or 3 ports. For the indication of full power precoder sets in a partially coherent scenario, UE 210 may indicate (e.g., via UE capability information) whether UE 210 supports full power transmission for each of the antenna group. This may be done, for example, using two bits, with a one bit indicating for a first antenna group (e.g., the two fully coherent antenna ports) and the 2nd bit indicating for the 2nd antenna group (e.g., the 3rd non-coherent antenna port). For the indication of full power precoder sets in a non-coherent scenario, UE 210 may use 6 bits to indicate (e.g., via UE capability information) which combinations of antenna ports may provide full power transmission, with each bit corresponding to one combination of antenna ports. This may be done, for example, to provide full flexibility in full power capability reporting from UE 210 to base station 222. Table 1 below is an example of a bitmap or index for use 6 bits to indicate which combinations of antenna ports may provide full power transmission.

TABLE 1

| Bit Index | Combination of Antenna Ports |
|---|---|
| 1 | 0 |
| 2 | 1 |
| 3 | 2 |
| 4 | 0 and 1 |
| 5 | 0 and 2 |
| 6 | 1 and 2 |

In some implementations, UE 210 may use fewer than 6 bits may be used to indicate which combinations of antenna ports may provide full power transmission. Table 2 below is an example of a bitmap or index for using 2 bits to indicate which combinations of antenna ports may provide full power transmission.

TABLE 2

| Bit Index | Combination of Antenna Ports |
|---|---|
| 1 | 0 |
| 2 | 0 and 1 |

Additionally, or alternatively, a scaler may be added to a precoder to normalize transmission power. For example, a typical scaler to be applied to a 3-Tx, fully coherent precoder may be 1/\sqrt{3} may be applied rank 1 precoders; a scaler of 1/\sqrt{6} may be applied rank 2 precoders, and a scaler of ⅓ may be applied to rank 3 precoders. Additionally, or alternatively, a codebook may include a subset of precoders. Further, the columns of a precoding matrix may be permutated in any way, and the resulting precoding matrix may be considered as effectively or functionally the same withing the scope of the techniques described herein. As such, a codebook as described herein may consist of any permutation of any of the precoding matrices and/or combinations of any of the precoding matrices described herein.

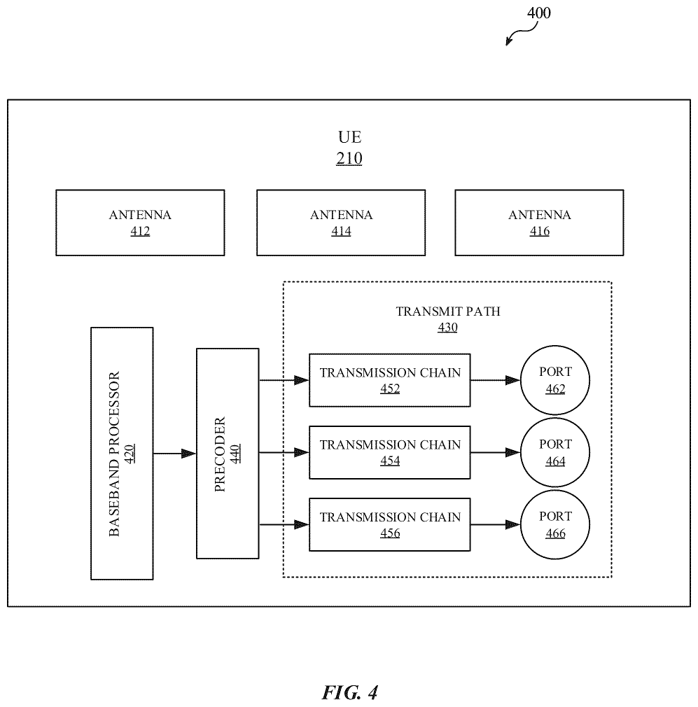

FIG. 4 is a diagram of an example 400 of a UE 210 according to one or more implementations described herein. As shown, UE 210 may include antennas 412, 414, and 416, baseband processor 420, and transmit path 430. In some implementations, UE 210 may include one or more components and/or features, such as a processor, memory, etc.

While UE 210 is depicted as having three antennas, in some implementations, UE 210 may have fewer antennas, additional antennas, and/or alternatively arranged antennas. Antennas 412, 414, and 416 may be arranged as a linear antenna array with equal spacing. In implementations, antennas 412, 414, and 416 may be arranged differently (e.g., different positions about UE 210 and/or with different spacing therebetween). A communication channel between UE 210 and base station 222 may include a physical channel, in addition to radio frequency (RF) transceiver chains that may include antennas, low-noise amplifiers (LNAs), mixers, RF filters, analog-to-digital (A/D) converters, and in-phase quadrature-phase (I/Q) imbalances, which may be different between different nodes and/or different antennas.

UE 210 may operate to use baseband processor 420 and transmit path 430 for UL transmissions using one or more antennas 412, 414, and 416. Baseband processor 420 may perform one or more of a variety of functions, such as data encoding, cyclic-prefix (CP)-OFDM, and discrete Fourier transform-spread-fast Fourier transform (DFT-s-FFT) modulation to generate a baseband signal. Transmit path 430 may include precoder 440, transmission chains 452, 454, and 456, and ports 462, 464, and 466. While UE 210 is depicted as having three transmission chains 452, 454, and 456, in some implementations, UE 210 may have fewer transmission chains, additional transmission chains, and/or alternatively arranged transmission chains. A transmission chain, as described herein, may include a digital-to-analog converter (DAC), a mixer, and a power amplifier that converts a baseband signal to a radio frequency (RF) signal for transmission. Additionally, or alternatively, a transmission chain may be routed to one or more antennas elements and/or ports 462, 464, and 466 through phase shifters and/or switches. Ports 462, 464, and/or 466 may be logical ports virtual ports.

UE 210 may communicate a UL transmission via a combination of transmission chains. Ports 462, 464, and/or 466, may (or may not) have a one-to-one mapping to antennas 412, 414, and/or 416. When there is a one-to-one mapping, each antenna 412, 414, and may map to one of ports 462, 464, and 466. When ports 462, 464, and 466 are logical ports or virtual ports, UE 210 may configure transmission chains 452, 454, and 456 differently for different ports such that signals may be produced with different characteristics (e.g., different transmission powers levels, different directions, etc.). Additionally, or alternatively, UE 210 may transmit a composite of the signals from transmission chains 452, 454, and 456 to base station 222 as corresponding to one or more virtual ports by applying precoder 440. Precoder 440 may include a transmit precoding matrix indicator (TPMI) precoder. Additionally, or alternatively, precoder 440 may be applied or implemented at baseband processor 420 or as part of transmit path 430. Precoder 440 may include a precoder for 3-Tx UL transmissions as described herein.

Ports 462, 464, and/or 466 may use discrete Fourier transform (DFT) vectors and/or an oversampling factor to construct fully coherent precoders. This is especially suitable when the 3 antenna ports form a linear array with equal spacing.

With antennas 412, 414, and 416 arranged as a linear array with equal spacing, precoding vectors for a 3-Tx port scenario may be represented as follows:

$${u}_{m} = [ \begin{matrix}1 & {e}^{j \frac{2 π m}{ON}} & {e}^{j \frac{2 π m ( N - 1 )}{ON}} ]\end{matrix}$$

u may be a precoded vector. N may be 3 (e.g., a number of transmission antennas), O may be an oversampling factor (e.g., 1, 2, 4, etc.); m is the index of the precoding vector and may be a value from 0 through ON−1, e may be the base of natural logarithms and equal to approximately 2.71828, π may be pi (is the ratio of a circle's circumference to its diameter), and j may be an imaginary unit. An oversampling factor of 1 (i.e., O=1) may represent no oversampling. There may be a total of ON precoding vectors. In some implementations, the precoding vectors for a 3-Tx port scenario may be represented as follows.

$${u}_{m} = [ \begin{matrix}1 \\ {e}^{j \frac{2 π m}{ON}} \\ {e}^{j \frac{2 π m ( N - 1 )}{ON}}\end{matrix} ]$$

A rank 1 precoder may include any of the precoding vectors. A rank 2 precoder may include two orthogonal precoding vectors, with a first precoding vector being any of the precoding vectors and a second precoding vector being one of the two precoding vectors that are orthogonal to the first precoding vector. A rank 3 precoder may include three orthogonal precoding vectors, where m=k, k+O, k+2O, and k may be equal to 0, 1, . . . , O−1.

The following are examples of rank 1 (or single layer) precoding matrixes using fully coherent 3-Tx ports with no oversampling (e.g., where O=1).

$$[ \begin{matrix}1 \\ 1 \\ 1\end{matrix} ] \qquad [ \begin{matrix}1 \\ {e}^{j \frac{2 π}{3}} \\ {e}^{j \frac{4 π}{3}}\end{matrix} ] \qquad [ \begin{matrix}1 \\ {e}^{j \frac{4 π}{3}} \\ {e}^{j \frac{2 π}{3}}\end{matrix} ]$$

The following are examples of rank 2 (e.g., double layer) precoding matrixes using fully coherent 3-Tx ports with no oversampling (e.g., where O=1).

$$[ \begin{matrix}1 & 1 \\ 1 & {e}^{j \frac{2 π}{3}} \\ 1 & {e}^{j \frac{4 π}{3}}\end{matrix} ] \qquad [ \begin{matrix}1 & 1 \\ 1 & {e}^{j \frac{4 π}{3}} \\ 1 & {e}^{j \frac{2 π}{3}}\end{matrix} ] \qquad [ \begin{matrix}1 & 1 \\ 1 {e}^{j \frac{2 π}{3}} & {e}^{j \frac{4 π}{3}} \\ 1 {e}^{j \frac{4 π}{3}} & {e}^{j \frac{2 π}{3}}\end{matrix} ]$$

The following are examples of rank 3 (e.g., third layer) precoding matrixes using fully coherent 3-Tx ports with no oversampling (e.g., where O=1).

$$[ \begin{matrix}1 & 1 & 1 \\ 1 & {e}^{j \frac{2 π}{3}} & {e}^{j \frac{4 π}{3}} \\ 1 & {e}^{j \frac{4 π}{3}} & {e}^{j \frac{2 π}{3}}\end{matrix} ]$$

The following are examples of rank 1 (e.g., first layer) precoding matrixes using fully coherent 3-Tx ports with an oversample factor of 2 (e.g., where O=2).

$$[ \begin{matrix}1 \\ 1 \\ 1\end{matrix} ] \qquad [ \begin{matrix}1 \\ {e}^{j \frac{π}{3}} \\ {e}^{j \frac{2 π}{3}}\end{matrix} ] \qquad [ \begin{matrix}1 \\ {e}^{j \frac{2 π}{3}} \\ {e}^{j \frac{4 π}{3}}\end{matrix} ] \qquad [ \begin{matrix}1 \\ - 1 \\ 1\end{matrix} ] \qquad [ \begin{matrix}1 \\ {e}^{j \frac{4 π}{3}} \\ {e}^{j \frac{2 π}{3}}\end{matrix} ] \qquad [ \begin{matrix}1 \\ {e}^{j \frac{5 π}{3}} \\ {e}^{j \frac{4 π}{3}}\end{matrix} ]$$

The following are examples of rank 2 (e.g., second layer) precoding matrixes using fully coherent 3-Tx ports with an oversample factor of 2 (e.g., where O=2).

$$[ \begin{matrix}1 & 1 \\ 1 & {e}^{j \frac{2 π}{3}} \\ 1 & {e}^{j \frac{4 π}{3}}\end{matrix} ] \qquad [ \begin{matrix}1 & 1 \\ 1 & {e}^{j \frac{4 π}{3}} \\ 1 & {e}^{j \frac{2 π}{3}}\end{matrix} ] \qquad [ \begin{matrix}1 & 1 \\ 1 {e}^{j \frac{2 π}{3}} & {e}^{j \frac{4 π}{3}} \\ 1 {e}^{j \frac{4 π}{3}} & {e}^{j \frac{2 π}{3}}\end{matrix} ]$$

$$[ \begin{matrix}1 & 1 \\ - 1 & {e}^{j \frac{π}{3}} \\ 1 & {e}^{j \frac{2 π}{3}}\end{matrix} ] \qquad [ \begin{matrix}1 & 1 \\ - 1 & {e}^{j \frac{5 π}{3}} \\ 1 & {e}^{j \frac{4 π}{3}}\end{matrix} ] \qquad [ \begin{matrix}1 & 1 \\ {e}^{j \frac{π}{3}} & {e}^{j \frac{5 π}{3}} \\ {e}^{j \frac{2 π}{3}} & {e}^{j \frac{4 π}{3}}\end{matrix} ]$$

The following are examples of rank 3 (e.g., second layer) precoding matrixes using fully coherent 3-Tx ports with an oversample factor of 2 (e.g., where O=2).

$$[ \begin{matrix}1 & 1 & 1 \\ 1 & {e}^{j \frac{2 π}{3}} & {e}^{j \frac{4 π}{3}} \\ 1 & {e}^{j \frac{4 π}{3}} & {e}^{j \frac{2 π}{3}}\end{matrix} ] \qquad [ \begin{matrix}1 & 1 & 1 \\ - 1 & {e}^{j \frac{π}{3}} & {e}^{j \frac{2 π}{3}} \\ 1 & {e}^{j \frac{2 π}{3}} & {e}^{j \frac{4 π}{3}}\end{matrix} ]$$

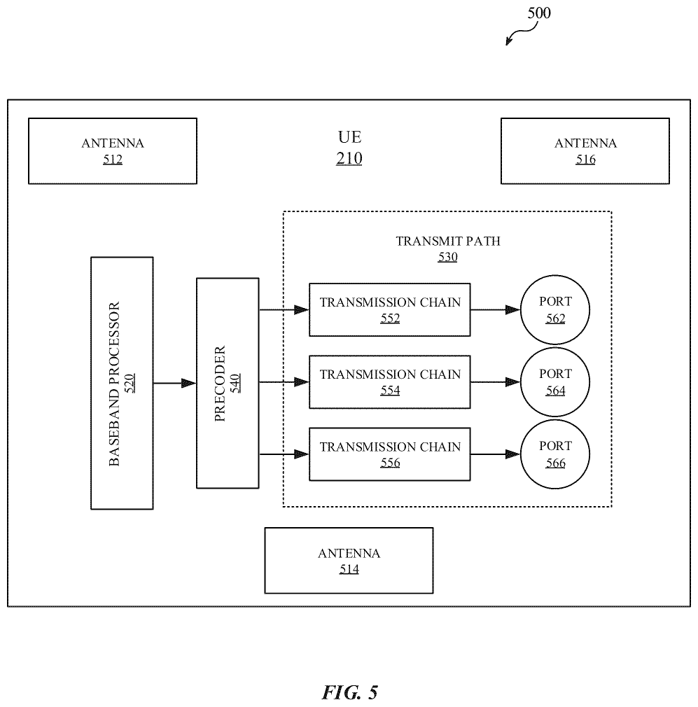

FIG. 5 is a diagram of an example 500 of a UE 210 according to one or more implementations described herein. As shown, UE 210 may include antennas 512, 514, and 516, baseband processor 520, and transmit path 530. In some implementations, UE 210 may include one or more components and/or features, such as a processor, memory, etc.

While UE 210 is depicted as having three antennas, in some implementations, UE 210 may have fewer antennas, additional antennas, and/or alternatively arranged antennas. Antennas 512, 514, and 516 may be arranged as a non-linear antenna array with or without equal spacing. A communication channel between UE 210 and base station 222 may include a physical channel, in addition to RF transceiver chains that may include antennas, LNAs, mixers, RF filters, A/D converters, and I/Q imbalances, which may be different between different nodes and/or different antennas.

UE 210 may operate to use baseband processor 520 and transmit path 530 for UL transmissions using one or more antennas 512, 514, and 516. Baseband processor 520 may perform one or more of a variety of functions, such as data encoding, cyclic-prefix (CP)-OFDM, and discrete Fourier transform-spread-fast Fourier transform (DFT-s-FFT) modulation to generate a baseband signal. Transmit path 530 may include precoder 540, transmission chains 552, 554, and 556, and ports 562, 564, and 566. While UE 210 is depicted as having three transmission chains 552, 554, and 556, in some implementations, UE 210 may have fewer transmission chains, additional transmission chains, and/or alternatively arranged transmission chains. A transmission chain, as described herein, may include a digital-to-analog converter (DAC), a mixer, and a power amplifier that converts a baseband signal to a radio frequency (RF) signal for transmission. Additionally, or alternatively, a transmission chain may be routed to one or more antennas elements and/or ports 562, 564, and 566 through phase shifters and/or switches. Ports 562, 564, and/or 566 may be logical ports virtual ports.

UE 210 may communicate a UL transmission via a combination of transmission chains. Ports 562, 564, and/or 566, may (or may not) have a one-to-one mapping to antennas 512, 514, and/or 516. When there is a one-to-one mapping, each antenna 512, 514, and may map to one of ports 562, 564, and 566. When ports 562, 564, and 566 are logical ports or virtual ports, UE 210 may configure transmission chains 552, 554, and 556 differently for different ports such that signals may be produced with different characteristics (e.g., different transmission powers levels, different directions, etc.). Additionally, or alternatively, UE 210 may report a composite of the signals from transmission chains 552, 554, and 556 to base station 222 as corresponding to one or more virtual ports by applying precoder 540. Precoder 540 may include a precoder. Additionally, or alternatively, precoder 540 may be applied or implemented at baseband processor 520 or as part of transmit path 530. Precoder 540 may include a precoder for 3-Tx UL transmissions as described herein.

Antennas 512, 514, and 516 may use DFT vectors and/or an oversampling factor to construct fully coherent precoders. In some implementations, fully coherent precoders may be designed to accommodate any antenna layout for antennas 512, 514, and 516 (e.g., other than, and/or in addition to, a linear antenna array with equal spacing as discussed above). In some implementations. antennas 512, 514, and 516 may be positioned or arranged to include a pair of cross-polarized (or cross-pol) antennas and another antenna that may be placed in another location, on UE 210, from the cross-pol antennas. Cross polarization may refer to orthogonal polarizations. For example, two antennas may be cross polarized when one a signal or field of one antenna is horizontally polarized and a signal or filed of the other antenna is vertical polarized. Alternatively, all of the antennas 512, 514, and 516 may be positioned or arranged on different locations of on UE 210.

The precoders may be constructed based on one or more of the following principles: 1) the phase offset between two antennas may be taken from a finite set of values (e.g., where the size of the set depends on a tradeoff between an overhead and a performance); 2) a phase offset between antennas “0” and “1” and a phase offset between antennas “0” and “2” may be selected independently; and 3) orthogonal vectors may be used for precoders with rank greater than 1.

In some implementations, precoder construction for a 3-Tx port scenario may include selecting, identifying, and/or defining a set of allowed phase offset values that may be represented as:

$${ϕ}_{k} = {e}^{j \frac{2 π k}{ON}}$$

Here, k may be 0, 1, . . . , ON−1, N may be 3, the number of transmitting antennas, and O is an integer or value that represents or determines a granularity of the phase offset. For example, the greater the value of O, the greater the number of supported phase offset. In such scenarios, a total of precoding vectors (ON×ON (e.g., O²N²)) for a rank 1 precoder may be represented as:

$${v}_{i , k} = [ \begin{matrix}1 \\ {ϕ}_{i} \\ {ϕ}_{k}\end{matrix} ]$$

Here, i may be 0, 1, . . . , ON−1, and k may be 0, 1, . . . , ON−1. In such scenarios, 3 orthogonal vectors, for a 3-Tx port scenario, may be represented as follows.

{v_{i,k}, v_{mod(i+O,ON),mod(k+2O,ON)}, v_{mod(i+2O,ON),mod(k+O,ON)}}

And within the O²N² vectors, there may be a total of O²N sets of orthogonal vectors.

Rank 2 precoders for a 3-Tx port scenario may use any 2 orthogonal vectors, which may be one of the following, with i=0, 1, . . . , ON−1, and k=0, 1, . . . , ON−1.

[v_{i,k}, v_{mod(i+O,ON),mod(k+2O,ON)}]

[v_{i,k}, v_{mod(i+2O,ON),mod(k+O,ON)}]

[v_{mod(i+O,ON),mod(k+2O,ON)}, v_{mod(i+2O,ON),mod(k+O,ON)}]

For the precoding matrices that may be column permutation of each other, only one may be included in a codebook. For each set of orthogonal vectors, there may be 3unique, rank 2 precoders. In such a scenario, therefore, there may be a total of 3O²N unique rank 2 precoders.

Rank 3 precoders for a 3-Tx port scenario may use 3 orthogonal vectors represented as:

[v_{i,k}, v_{mod(i+O,ON),mod(k+2O,ON)}, v_{mod(i+2O,ON),mod(k+O,ON)}]
where i=0, 1, . . . , ON−1, and k=0, 1, . . . , ON−1. Similarly, when the precoding matrices that are column permutation of another preceding matrix are not counted, there may be a total of O²N unique precoders.

In some implementations, the value of an oversampling factor O may be 1. In such scenarios, a set of allowed phase offsets may be represented as follows.

$$\{ 1 , {e}^{j \frac{2 π}{3}} , {e}^{j \frac{4 π}{3}} \}$$

The 3 values for the allowed phase offsets may be denoted as: ϕ₀, ϕ₁, ϕ₂, respectively, where

$${ϕ}_{k} = {e}^{j \frac{2 π k}{3}} ,$$

k=0, 1, 2, which may be used to facilitate the construction of orthogonal vectors.

A rank 1 precoder scenario, with an oversampling factor of O=1, may include a total of 3×3=9 vectors, which may be represented as:

$${v}_{i , k} = [ \begin{matrix}1 \\ {ϕ}_{i} \\ {ϕ}_{k}\end{matrix} ]$$

Here, i may be 0, 1, 2, and k may be 0, 1, 2. In such scenarios, the 9 precoding vectors for rank 2 (e.g., double layer) precoding using fully coherent 3-Tx ports with no oversampling (e.g., where O=1) may be represented, for example, as the following.

$$\begin{matrix}{v}_{0 , 0} = [ \begin{matrix}1 \\ 1 \\ 1\end{matrix} ] & {v}_{0 , 1} = [ \begin{matrix}1 \\ 1 \\ {e}^{j \frac{2 π}{3}}\end{matrix} ] , & {v}_{0 , 2} = [ \begin{matrix}1 \\ 1 \\ {e}^{j \frac{4 π}{3}}\end{matrix} ] , \\ {v}_{1 , 0} = [ \begin{matrix}1 \\ {e}^{j \frac{2 π}{3}} \\ 1\end{matrix} ] , & {v}_{1 , 1} = [ \begin{matrix}1 \\ {e}^{j \frac{2 π}{3}} \\ {e}^{j \frac{2 π}{3}}\end{matrix} ] , & {v}_{1 , 2} = [ \begin{matrix}1 \\ {e}^{j \frac{2 π}{3}} \\ {e}^{j \frac{4 π}{3}}\end{matrix} ] , \\ {v}_{2 , 0} = [ \begin{matrix}1 \\ {e}^{j \frac{4 π}{3}} \\ 1\end{matrix} ] , & {v}_{2 , 1} = [ \begin{matrix}1 \\ {e}^{j \frac{4 π}{3}} \\ {e}^{j \frac{2 π}{3}}\end{matrix} ] , & {v}_{2 , 2} = [ \begin{matrix}1 \\ {e}^{j \frac{4 π}{3}} \\ {e}^{j \frac{4 π}{3}}\end{matrix} ]\end{matrix}$$

In such scenarios, 3 sets of orthogonal vectors may be represented as follows.

{v_{0,0}, v_{1,2}, v_{2,1}}, {v_{0,1}, v_{1,0}, v_{2,2}}, {v_{0,2}, v_{1,1}, v_{2,0}}

In a rank 2 precoder scenario (e.g., double layer) using fully coherent 3-Tx ports with no oversampling (e.g., where O=1), the precoding vectors may be represented by the following precoding matrixes that each include 2 orthogonal vectors.

$$\begin{matrix}[ \begin{matrix}1 & 1 \\ 1 & {e}^{j \frac{2 π}{3}} \\ 1 & {e}^{j \frac{4 π}{3}}\end{matrix} ] & [ \begin{matrix}1 & 1 \\ 1 & {e}^{j \frac{4 π}{3}} \\ 1 & {e}^{j \frac{2 π}{3}}\end{matrix} ] & [ \begin{matrix}1 & 1 \\ 1 {e}^{j \frac{2 π}{3}} & {e}^{j \frac{4 π}{3}} \\ 1 {e}^{j \frac{4 π}{3}} & {e}^{j \frac{2 π}{3}}\end{matrix} ] \\ [ \begin{matrix}1 & 1 \\ 1 & {e}^{j \frac{2 π}{3}} \\ {e}^{j \frac{2 π}{3}} & 1\end{matrix} ] & [ \begin{matrix}1 & 1 \\ 1 & {e}^{j \frac{4 π}{3}} \\ {e}^{j \frac{2 π}{3}} & {e}^{j \frac{4 π}{3}}\end{matrix} ] & [ \begin{matrix}1 & 1 \\ {e}^{j \frac{2 π}{3}} & {e}^{j \frac{4 π}{3}} \\ 1 & {e}^{j \frac{4 π}{3}}\end{matrix} ] \\ [ \begin{matrix}1 & 1 \\ 1 & {e}^{j \frac{4 π}{3}} \\ {e}^{j \frac{4 π}{3}} & 1\end{matrix} ] & [ \begin{matrix}1 & 1 \\ 1 & {e}^{j \frac{2 π}{3}} \\ {e}^{j \frac{4 π}{3}} & {e}^{j \frac{2 π}{3}}\end{matrix} ] & [ \begin{matrix}1 & 1 \\ {e}^{j \frac{4 π}{3}} & {e}^{j \frac{2 π}{3}} \\ 1 & {e}^{j \frac{2 π}{3}}\end{matrix} ]\end{matrix}$$

In a rank 2 precoder scenario, each of the matrices (as shown above) may include 2 orthogonal vectors.

In a rank 3 precoder scenario (e.g., triple layer) using fully coherent 3-Tx ports with no oversampling (e.g., where O=1), the precoding vectors may be represented by the following precoding matrixes that each include one set of 3 orthogonal vectors.

$$[ \begin{matrix}1 & 1 & 1 \\ 1 & {e}^{j \frac{2 π}{3}} & {e}^{j \frac{4 π}{3}} \\ 1 & {e}^{j \frac{4 π}{3}} & {e}^{j \frac{2 π}{3}}\end{matrix} ] \qquad [ \begin{matrix}1 & 1 & 1 \\ 1 & {e}^{j \frac{2 π}{3}} & {e}^{j \frac{4 π}{3}} \\ {e}^{j \frac{2 π}{3}} & 1 & {e}^{j \frac{4 π}{3}}\end{matrix} ] \qquad [ \begin{matrix}1 & 1 & 1 \\ 1 & {e}^{j \frac{4 π}{3}} & {e}^{j \frac{2 π}{3}} \\ {e}^{j \frac{4 π}{3}} & 1 & {e}^{j \frac{2 π}{3}}\end{matrix} ]$$

As shown, each of these matrices may include 3 orthogonal vectors. In some implementations, the value of an oversampling factor O may be 2. In such scenarios, a set of allowed phase offsets may be as follows.

$$\{ 1 , {e}^{j \frac{π}{3}} , {e}^{j \frac{2 π}{3}} , - 1 , {e}^{j \frac{4 π}{3}} , {e}^{j \frac{5 π}{3}} \}$$

The 6 values for the allowed phase offsets may be represented as:

$${ϕ}_{k} = {e}^{j \frac{π k}{3}}$$

Here, ϕ may be a phase of a corresponding signal vector, k may be 0, 1, . . . , 5, e may be the base on natural logarithms and equal to approximately 2.71828, π may be pi (is the ratio of a circle's circumference to its diameter), and j may be the imaginary unit. Implementations with an oversampling factor of O=2, may have a finer granularity of the phase offset between transmission signals than implementations with an oversampling factor of 1 (as described above).

There are a total of 6×6=36 rank 1 precoders, each being a precoding vector, which may be represented as:

$${v}_{i , k} = [ \begin{matrix}1 \\ {ϕ}_{i} \\ {ϕ}_{k}\end{matrix} ]$$

v may be a vector, i may be equal to 0, 1, . . . , 5, k may be equal to 0, 1, . . . , 5, and ϕ may be a phase of a corresponding signal vector. In contrast to one or more of the examples described above relating to precoding vectors where an oversampling value (O) is 1, individual vectors may not be provided below for precoding vectors where O=2 because the total number of precoders may be much larger. Within the 36 precoding vectors, each set of three orthogonal vectors for may be represented as follows.

{v_{i,k}, v_{mod(i+2,6),mod(k+4,6)}, v_{mod(i+4,6),mod(k+2,6)}}

And there may be a total of 12 sets of 3 orthogonal vectors. Rank 2 precoders, with an oversampling factor of O=2, may use any two orthogonal vectors, which may be one of the following with i=0, 1, . . . , 5, and k=0, 1, . . . , 5. A rank 2 precoder may be represented by any of the following.

[v_{i,k}, v_{mod(i+2,6),mod(k+4,6)}]

[v_{i,k}, v_{mod(i+4,6),mod(k+2,6)}]

[v_{mod(i+2,6),mod(k+4,6)}, v_{mod(i+4,6),mod(k+2,6)}]

For the precoding matrices that may be column permutation of each other, only or at least one may be included in a codebook. For each set of orthogonal vectors, there may be 3 unique, rank 2 precoders. In such a scenario, therefore, there may be a total of 36 unique rank 2 precoders. A rank 3 precoder, with an oversampling factor of O=2, consists of 3 orthogonal vectors, and may be represented as:

[v_{i,k}, v_{mod(i+2,6),mod(k+4,6)}, v_{mod(i+4,6),mod(k+2,6)}]

Here, i may be 0, 1, . . . , 5, and k may be 0, 1, . . . , 5. Similarly, when the precoding matrices that are column permutation of another preceding matrix are not counted, there may be a total of 12 unique precoders. In some implementations, a scaler (e.g., a scaling factor) may be added to precoders to normalize transmit power. The scaler may vary depending on the precoder rank. A scaler of 1/\sqrt{3} may be applied rank 1 precoders; a scaler of 1/\sqrt{6} may be applied rank 2 precoders, and a scaler of ⅓ may be applied rank 3 precoders. In some implementations, precoders corresponding to one or multiple options can be specified. An example of an option, in this context, may include the precoders constructed based on DFT vectors, or the precoders constructed based on the allow phase offsets, as described above.

Additionally, or alternatively, precoders or groups of precoders may be specified for more oversampling values (O). For example, a set of precoders may be specified assuming O=1, and a different set of precoders may be specified assuming O=2. A codebook may include the precoders or a subset of the full-coherent precoders corresponding to one or multiple options and/or one or multiple values of O. A codebook may include any combination of fully coherent precoders, partial-coherent, or non-coherent precoders.

In some implementations, when precoders corresponding to multiple options and/or multiple values of O are specified, UE 210 may report which option(s) and/or which values of O are supported by UE 210 via UE capability information provided to base station 222. In response, base station 222 may configure UE 210 (via DCI or another type of UE configuration information) with a codebook accordingly. Additionally, or alternatively, columns of a precoding matrix may be permutated in any way, and the resulting precoding matrix may be considered as effectively the same. Therefore, the techniques described herein include a codebook that includes precoding matrices explicitly described herein and/or any type of permutation thereof.

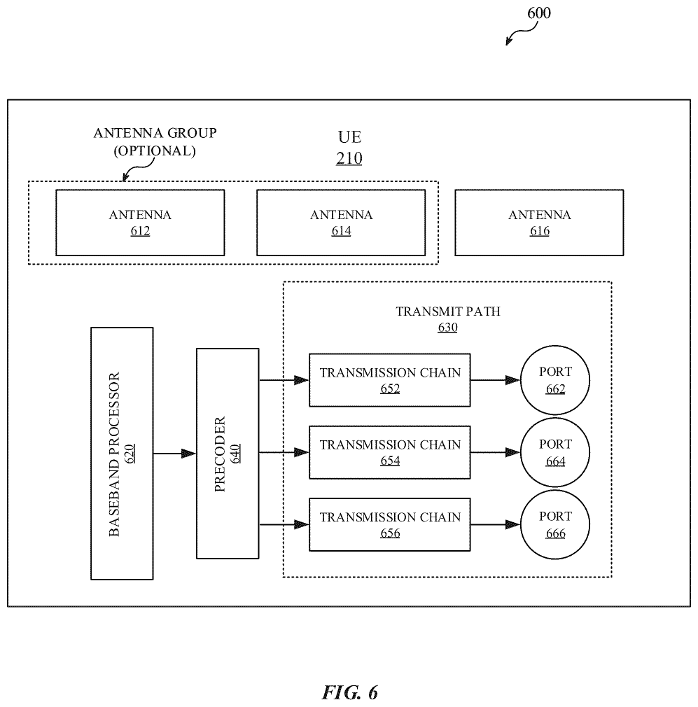

FIG. 6 is a diagram of an example 600 of a UE 210 according to one or more implementations described herein. As shown, UE 210 may include antennas 612, 614, and 616, baseband processor 620, transmit path 630, transmission chains 652, 654, and 656, and ports 662, 664, and 666. In some implementations, UE 210 may include one or more components and/or features, such as a processor, memory, etc. The features and components of UE 210 in example 600 may be similar to those described above with reference to FIG. 4 or 5. As shown, antennas 612 and 614 may be arranged or configured to operate as an antenna group or group of ports. Antenna 616 may not be part of the antenna group or group of ports. As such, antennas 612 and 614 may be fully coherent with respect to one another and non-coherent with respect to antenna 616. In such a scenario, UE 210 may be described as operating in a partially coherent mode.

When operating in a fully coherent mode, UE 210 may transmit coherently or consistently over all antenna ports. A fully coherent UE may control the maximum difference between the relative power and phase errors between different antenna ports of UE 210 within a certain time window (e.g. 20 ms, or from the measured SRS to the PUSCH transmission with the indicated precoder). This ensures the effectiveness of the indicated precoder for PUSCH. A fully coherent precoder, as described herein, may be designed for a 3-Tx linear antenna array (e.g., a 1×3 array) with equal spacing.

When operating in a partially coherent mode, UE 210 may transmit coherently (e.g., consistently) over some but not all the antenna ports 662, 664, and 666 and/or antennas 612, 614, and 616. A partially coherent UE 210 may be capable of maintain coherency within one or more subsets, groups, or pairs of antenna ports. For example, a pair of antenna ports may be coherent with respect to each other. Meanwhile, a remaining antenna port (e.g., antenna 616) may be non-coherent with respect to the coherent antenna ports. In such a scenario, grouped antenna ports may operate, in this regard, as independent from non-grouped antenna port, and thus UE 210 may be partially coherent.

The precoders for a partially coherent UE 210 may be constructed using two sub-precoders. One precoder for grouped antennas or antenna ports (e.g., antennas 612 and 614), and another precoder for the remaining antenna or antenna port (e.g., antenna 616). For rank 1, the precoder may be represented as either of the following, so long as only one of the group antennas or the non-grouped antennas are used.

$$[ \begin{matrix}W 1 \\ 0\end{matrix} ] OR [ \begin{matrix}0 \\ W 2\end{matrix} ]$$

W1 may correspond to grouped antennas 612 and 614. W2 may correspond to non-grouped antenna 616. And for rank 1 scenarios, the following precoders may be applied to the grouped antennas 612 and 614.

$$[ \begin{matrix}1 \\ 1\end{matrix} ] \qquad [ \begin{matrix}1 \\ - 1\end{matrix} ] \qquad [ \begin{matrix}1 \\ j\end{matrix} ] \qquad [ \begin{matrix}1 \\ - j\end{matrix} ]$$

For rank 2, a precoder may be represented as the following when the non-grouped antenna is not used, where W1 has two columns, representing a Rank 2 precoder for 2Tx.

$$[ \begin{matrix}W 1 \\ 0\end{matrix} ]$$

Alternatively, for rank 2, a precoder may be represented as the following when both the grouped antennas and the non-grouped antennas are used, where W1 has a single column, representing a Rank 1 precoder for 2Tx (as provided above). The following may also, or alternatively, represent a precoder for a rank 3 scenarios has two columns, representing a Rank 2 precoder for 2Tx.

$$[ \begin{matrix}W 1 & 0 \\ 0 & W 2\end{matrix} ]$$

W1 may correspond to grouped antennas 612 and 614. W2 may correspond to non-grouped antenna 616. And for rank 2 and/or rank 3 scenarios, the following precoders may be applied to the grouped antennas 612 and 614 if a Rank 2 precoder is needed for W1, or the vectors above if a Rank 1 precoder is needed. As W2 may correspond to non-grouped antenna 616, W2 may be a scalar equal to 1.

$$[ \begin{matrix}1 & 1 \\ 1 & - 1\end{matrix} ] \qquad [ \begin{matrix}1 & 1 \\ j & - j\end{matrix} ]$$

A precoder used by UE 210 for a rank 1 scenario when only grouped antennas 612 and 614 are used may be represented by one or more of the following.

$$[ \begin{matrix}1 \\ 1 \\ 0\end{matrix} ] \qquad [ \begin{matrix}1 \\ - 1 \\ 0\end{matrix} ] \qquad [ \begin{matrix}1 \\ j \\ 0\end{matrix} ] \qquad [ \begin{matrix}1 \\ - j \\ 0\end{matrix} ]$$

When only the non-grouped antenna is used in a rank 1 scenario, UE 210 may use a precoder represented by one or more of the following.

$$[ \begin{matrix}0 \\ 0 \\ 1\end{matrix} ]$$

A precoder used by UE 210 for a rank 2 scenario when only grouped antennas 612 and 614 are used may be represented by one or more of the following.

$$[ \begin{matrix}1 & 1 & 0 \\ 1 & - 1 & 0 \\ 0 & 0 & 0\end{matrix} ] \qquad [ \begin{matrix}1 & 1 & 0 \\ j & - j & 0 \\ 0 & 0 & 0\end{matrix} ]$$

A precoder used by UE 210 for a rank 2 scenario when grouped antennas 612 and 614 and non-grouped antennas 616 are used may be represented by one or more of the following.

$$[ \begin{matrix}1 & 0 \\ 1 & 0 \\ 0 & 0\end{matrix} ] \qquad [ \begin{matrix}1 & 0 \\ - 1 & 0 \\ 0 & 0\end{matrix} ] \qquad [ \begin{matrix}1 & 0 \\ j & 0 \\ 0 & 1\end{matrix} ] \qquad [ \begin{matrix}1 & 0 \\ - j & 0 \\ 0 & 1\end{matrix} ]$$

A precoder used by UE 210 for a rank 3 scenario when grouped antennas 612 and 614 and non-grouped antennas 616 are used may be represented by one or more of the following.

$$[ \begin{matrix}1 & 1 & 0 \\ 1 & - 1 & 0 \\ 0 & 0 & 1\end{matrix} ] \qquad [ \begin{matrix}1 & 1 & 0 \\ j & - j & 0 \\ 0 & 0 & 1\end{matrix} ]$$

When operating in a non-coherent mode, UE 210 may not be able to maintain coherency over antenna ports 662, 664, and 666 and/or antennas 612, 614, and 616. In such a scenario, UE 210 of example 500 may not have an antenna group. A non-coherent UE may not transmit coherently across any pair, set or combination of antenna ports and/or antennas.

A precoder used by UE 210 for a rank 1 scenario in a non-coherent mode may be represented by one or more of the following.

$$[ \begin{matrix}1 \\ 0 \\ 0\end{matrix} ] \qquad [ \begin{matrix}0 \\ 1 \\ 0\end{matrix} ] \qquad [ \begin{matrix}0 \\ 0 \\ 1\end{matrix} ]$$

A precoder used by UE 210 for a rank 2 scenario in a non-coherent mode may be represented by one or more of the following.

$$[ \begin{matrix}1 & 0 \\ 0 & 1 \\ 0 & 0\end{matrix} ] \qquad [ \begin{matrix}1 & 0 \\ - 1 & 0 \\ 0 & 0\end{matrix} ] \qquad [ \begin{matrix}1 & 0 \\ 0 & 0 \\ 0 & 1\end{matrix} ] \qquad [ \begin{matrix}0 & 0 \\ 1 & 0 \\ 0 & 1\end{matrix} ]$$

A precoder used by UE 210 for a rank 3 scenario in a non-coherent mode may be represented by one or more of the following.

$$[ \begin{matrix}1 & 0 & 0 \\ 0 & 1 & 0 \\ 0 & 0 & 1\end{matrix} ]$$

A codebook configured for UE 210 may include fully coherent precoders only, partially coherent precoders only, non-coherent precoders only, or any combinations of fully coherent precoders, partially coherent precoders, and/or non-coherent precoders. A RI and/or TPMI may be indicated in DCI so that UE 210 may rank appropriately the corresponding precoder to for use in transmission. The following options may be applicable for any codebook.

In option 1, there may be a joint indication of RI and TPMI. In such a scenario, each rank (e.g., rank 1, 2, and 3) precoding matrices may be provided with a unique index. The index of a precoding matrix may be indicated in a DCI field. In option 2, there may be a separate indication of RI and TPMI. In such scenarios, each precoder may be provided with a unique index within the precoders with the same rank. Additionally, RI and TPMI may be indicated separately in DCI (e.g., either two DCI fields or the two DCI sub-fields in a DCI field). In such scenarios, TPMI may refer to a precoder index among precoders with the same rank.

In option 3, an RI/TPMI indication may be done via two TPMI indications (e.g., one for each antenna group). Such a scenario may be implemented when a configured codebook only consists of partially coherent precoders. In such a scenario, a first TPMI indication may provide a precoder for a first antenna group, which may indicate one of the 6 fully coherent 2Tx UL precoders, plus one entry indicating the antenna group is not used. A second TPMI indication may be a single bit, which is either 0 (antenna not used) or 1 (antenna used) or vice versa. Additionally, or alternatively, an RI/TPMI indication may be done via two TPMI indications (e.g., one for each antenna group) when a configured codebook only consists of non-coherent precoders. In such a scenario, a first TPMI indication may provide a precoder for a first antenna group, which may indicate one of the 3 non-coherent 2Tx UL precoders, plus one entry indicating the antenna group is not used. A second TPMI indication may be a single bit, which may be either 0 (antenna not used) or 1 (antenna used) or vice versa. Additionally, or alternatively, an RI/TPMI indication may be done via two TPMI indications (e.g., one for each antenna group) when a configured codebook consists of both partially coherent and non-coherent precoders. In such a scenario, a first TPMI indication may provide a precoder for the first antenna group, which may indicate one of the 9 fully coherent and non-coherent 2Tx UL precoders, plus one entry indicating the antenna group is not used. A second TPMI indication may be a single bit, which is either 0 (antenna not used) or 1 (antenna used) or vice versa.

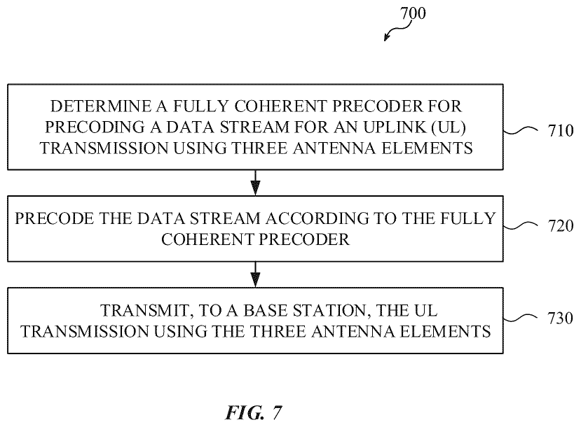

FIG. 7 is a diagram of an example of a process for precoding and signaling for UL transmissions via three transmit antenna ports according to one or more implementations described herein. Process 400 may be implemented by UE 210. In some implementations, some or all of process 700 may be performed by one or more other systems or devices, including one or more of the devices of FIG. 2. Additionally, process 700 may include one or more fewer, additional, differently ordered and/or arranged operations than those shown in FIG. 7. In some implementations, some or all of the operations of process 700 may be performed independently, successively, simultaneously, etc., of one or more of the other operations of process 700. As such, the techniques described herein are not limited to a number, sequence, arrangement, timing, etc., of the operations or processes depicted in FIG. 7.

As shown, process 700 may include determining a fully coherent precoder for precoding a data stream for an uplink (UL) transmission using three antennas (block 710). Process 700 may include precoding the data stream according to the fully coherent precoder. Process 700 may include transmitting, to a base station, the UL transmission using the three antennas. Process 700 may also, or alternatively include one or more of the operations, examples, or aspects of the techniques described herein.

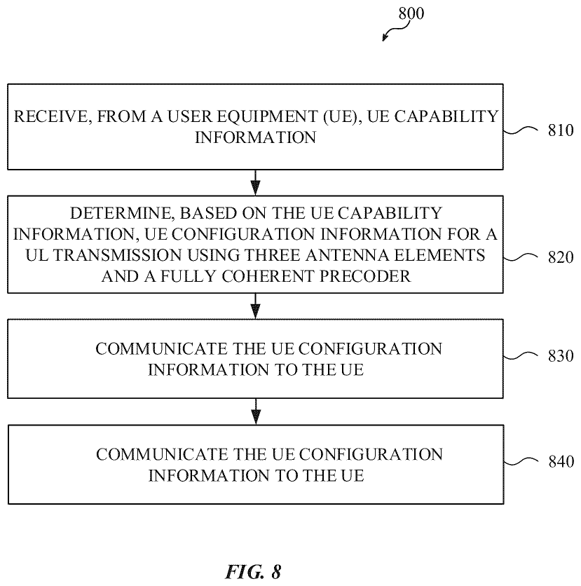

FIG. 8 is a diagram of an example of a process for precoding and signaling for UL transmissions via three transmit antenna ports according to one or more implementations described herein. Process 800 may be implemented by base stations 222. In some implementations, some or all of process 800 may be performed by one or more other systems or devices, including one or more of the devices of FIG. 2. Additionally, process 800 may include one or more fewer, additional, differently ordered and/or arranged operations than those shown in FIG. 8. In some implementations, some or all of the operations of process 800 may be performed independently, successively, simultaneously, etc., of one or more of the other operations of process 800. As such, the techniques described herein are not limited to a number, sequence, arrangement, timing, etc., of the operations or processes depicted in FIG. 8.

Process 800 may include receiving, from a user equipment (UE), UE capability information (block 810). Process 800 may include determining, based on the UE capability information, UE configuration information for a UL transmission using three antennas and a fully coherent precoder (block 820). Process 800 may include communicating the UE configuration information to the UE (block 830). Process 800 may include receiving, from the UE, a UL transmission using the three antennas (block 840). Process 800 may also, or alternatively include one or more of the operations, examples, or aspects of the techniques described herein.

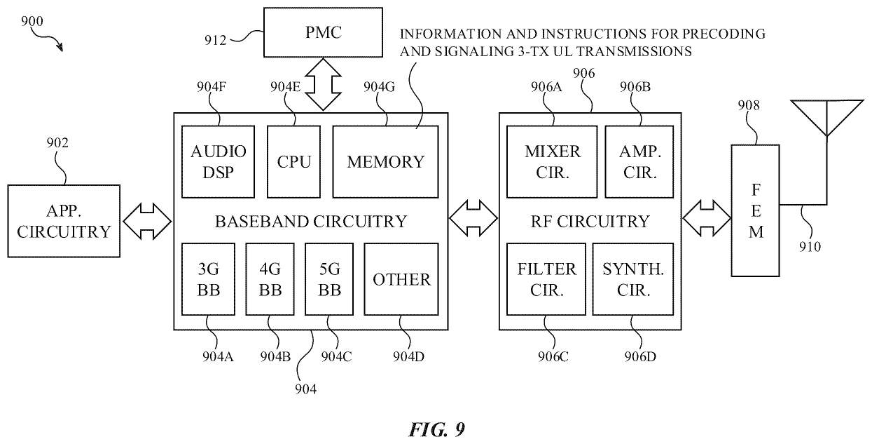

FIG. 9 is a diagram of an example of components of a device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuity 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.). The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 904G may receive and/or store information and instructions for enabling UE 210, and/or one or more components thereof, to fully coherent, partially coherent, and/or non-coherent precoding for uplink (UL) transmissions using three antenna or antennas. Many examples of precoding matrices, precoding vectors, and phase shifts are described herein, including factors, conditions, and calculations that may be applicable depending on a given scenario or in a given implementation.

In some implementations, the baseband circuitry 904 can include one or more audio digital signal processor(s) (DSP) 904F. The audio DSPs 904F can include elements for compression/decompression and echo cancellation and can include other suitable processing clements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path. In some implementations, the mixer circuitry 906A of the receive signal path can be configured to down-convert RF signals received from the FEM circuitry 908 based on the synthesized frequency provided by synthesizer circuitry 906D. The amplifier circuitry 906B can be configured to amplify the down-converted signals and the filter circuitry 906C can be a low-pass filter (LPF) or band-pass filter (BPF) configured to remove unwanted signals from the down-converted signals to generate output baseband signals. Output baseband signals can be provided to the baseband circuitry 904 for further processing. In some implementations, the output baseband signals can be zero-frequency baseband signals, although this is not a requirement. In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 908. The baseband signals can be provided by the baseband circuitry 904 and can be filtered by filter circuitry 906C.

In some implementations, the mixer circuitry 906A of the receive signal path and the mixer circuitry 906A of the transmit signal path can include two or more mixers and can be arranged for quadrature down conversion and up conversion, respectively. In some implementations, the mixer circuitry 906A of the receive signal path and the mixer circuitry 906A of the transmit signal path can include two or more mixers and can be arranged for image rejection (e.g., Hartley image rejection). In some implementations, the mixer circuitry 906A of the receive signal path and the mixer circuitry 1406A can be arranged for direct down conversion and direct up conversion, respectively. In some implementations, the mixer circuitry 906A of the receive signal path and the mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 906 can include analog-to-digital converter (ADC) and digital-to-analog converter (DAC) circuitry and the baseband circuitry 904 can include a digital baseband interface to communicate with the RF circuitry 906.

In some dual-mode implementations, a separate radio IC circuitry can be provided for processing signals for each spectrum, although the scope of the implementations is not limited in this respect.

In some implementations, the synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

The synthesizer circuitry 906D can be configured to synthesize an output frequency for use by the mixer circuitry 906A of the RF circuitry 906 based on a frequency input and a divider control input. In some implementations, the synthesizer circuitry 906D can be a fractional N/N+1 synthesizer.

In some implementations, frequency input can be provided by a voltage-controlled oscillator (VCO), although that is not a requirement. Divider control input can be provided by either the baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of the RF circuitry 906 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay clements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 906 can include an IQ/polar converter.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the FEM circuitry 908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 may be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as Discontinuous Reception Mode (DRX) after a period of inactivity. During this state, the device 900 can power down for brief intervals of time and thus save power.

If there is no data traffic activity for an extended period of time, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 902 and processors of the baseband circuitry 904 can be used to execute elements of one or more instances of a protocol stack. For example, processors of the baseband circuitry 904, alone or in combination, can be used execute Layer 3, Layer 2, or Layer 1 functionality, while processors of the baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

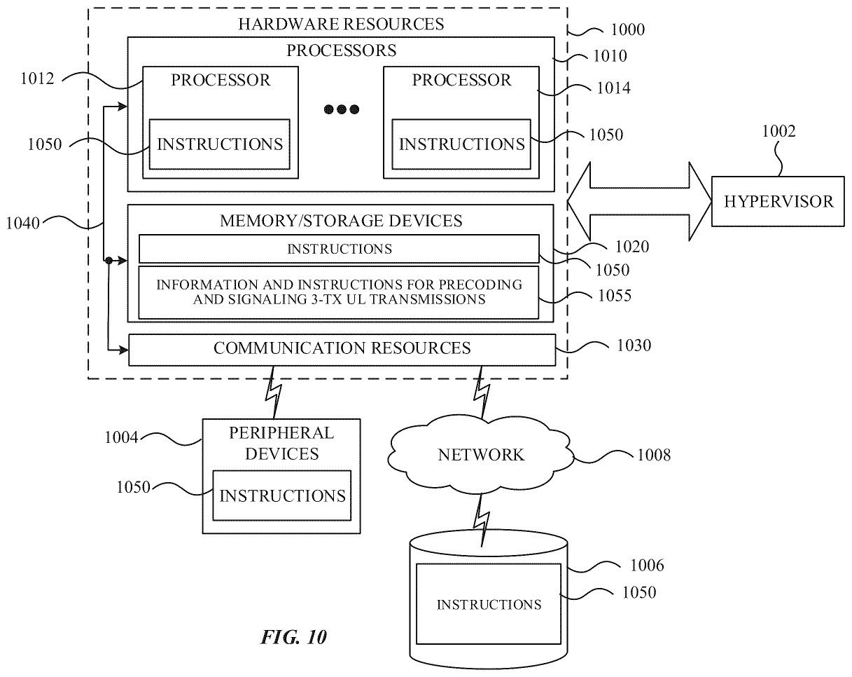

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For implementations where node virtualization (e.g., NFV) is utilized, a hypervisor may be executed to provide an execution environment for one or more network slices/sub-slices to utilize the hardware resources 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1014.

The memory/storage devices 1020 may include main memory, disk storage, or any suitable combination thereof. The memory/storage devices 1020 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1020 receive and/or store information and instructions 1055 for enabling UE 210, and/or one or more components thereof, to engage in fully coherent, partially coherent, and/or non-coherent precoding for uplink (UL) transmissions using three antenna or antennas. Many examples of precoding matrices, precoding vectors, and phase shifts are described herein, including factors, conditions, and calculations that may be applicable depending on a given scenario or in a given implementation.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE), may comprise a memory; and one or more processors configured to, when executing instructions stored in the memory, cause the UE to: determine a fully coherent precoder for precoding a data stream for an uplink (UL) transmission using three antenna ports; precode the data stream according to the fully coherent precoder; and transmit, to a base station, the UL transmission using the three antenna ports.

In example 2, which may also include one or more of the examples described herein, the three antenna ports comprise a linear array of equally spaced antennas.

In example 3, which may also include one or more of the examples described herein, precoding vectors of the fully coherent precoder are based on a number of antenna ports and an oversampling factor associated with the UL transmission.

In example 4, which may also include one or more of the examples described herein, the fully coherent precoders are constructed based on a number of antenna ports and a set of precoding vectors.

In example 5, which may also include one or more of the examples described herein, a precoder vector is represented by:

$${u}_{m} = [ \begin{matrix}1 \\ {e}^{j \frac{2 π m}{ON}} \\ {e}^{j \frac{2 π m ( N - 1 )}{ON}}\end{matrix} ]$$

where N is 3, O is an oversampling factor; m is the index of the precoding vector a value from 0 through ON−1, e is a base of a natural logarithm, π is a ratio of a circumference of a circle relative to a diameter of the circle, and j is an imaginary unit.

In example 7, which may also include one or more of the examples described herein, a precoder vector is represented by:

$${v}_{i , k} = [ \begin{matrix}1 \\ {ϕ}_{i} \\ {ϕ}_{k}\end{matrix} ] ,$$

where

$${ϕ}_{k} = {e}^{j \frac{2 π k}{ON}}$$

represents the phase offset between two antenna ports, N is 3, i or k may be 0, 1, . . . , ON−1, and O is an integer or value that determines a granularity of the phase offset.

In example 8, which may also include one or more of the examples described herein, a rank 1 precoder of the fully coherent precoders compromises a precoding vector from the set of the precoding vectors.

In example 9, which may also include one or more of the examples described herein, a rank 2 precoder of the fully coherent precoders compromises two orthogonal precoding vectors from the set of the precoding vectors.

In example 10, which may also include one or more of the examples described herein, a rank 3 precoder of the fully coherent precoders compromises three orthogonal precoding vectors from the set of the precoding vectors.

In example 11, which may also include one or more of the examples described herein, precoding vectors, of the fully coherent precoder, are based on a rank of the fully coherent precoder.

In example 12, which may also include one or more of the examples described herein, the fully coherent precoder comprises a rank 1 precoder and a precoding vector applied to the UL transmission comprises any precoding vector of the fully coherent precoder.

In example 13, which may also include one or more of the examples described herein, the fully coherent precoder is a rank 2 precoder and precoding vectors applied to the UL transmission comprise two orthogonal precoding vectors.

In example 14, which may also include one or more of the examples described herein, the fully coherent precoder is a rank 3 precoder and precoding vectors applied to the UL transmission comprise three orthogonal precoding vectors.

In example 15, which may also include one or more of the examples described herein, a number of precoding matrixes, of the fully coherent precoder, increases in accordance with an increase of an oversampling factor associated with the UL transmission.

In example 16, which may also include one or more of the examples described herein, precoding vectors applied to the UL transmission is represented by: \

$${u}_{m} = [ \begin{matrix}1 & {e}^{j \frac{2 π m}{ON}} & {e}^{j \frac{2 π m ( N - 1 )}{ON}}\end{matrix} ] ,$$

where, N is 3, O is an oversampling factor; m is a value from 0 through ON−1, e is a base of a natural logarithm, π is a ratio of a circumference of a circle relative to a diameter of the circle, and j is an imaginary unit.

In example 17, which may also include one or more of the examples described herein, a scaler is applied to precoders of the UL transmission to normalize transmit power.

In example 18, which may also include one or more of the examples described herein, the fully coherent precoder is determined based on an oversampling factor.

In example 19, which may also include one or more of the examples described herein, the fully coherent precoder is part of a codebook, and the UE is configured to receive the codebook from the base station in response to providing the base station with UE capability information.

In example 20, which may also include one or more of the examples described herein, the three antenna ports comprise a non-linear array of non-equally spaced antennas.

In example 21, which may also include one or more of the examples described herein, a phase offset for precoding vectors applied to the UL transmission may be based on a number of transmission elements and a phase offset granularity value.

In example 22, which may also include one or more of the examples described herein, the fully coherent precoder comprises a rank 1 precoder consisting of three orthogonal vectors that each comprise a set of orthogonal vectors.

In example 23, which may also include one or more of the examples described herein, the fully coherent precoder is a rank 2 precoder and precoding vectors applied to the UL transmission comprise two orthogonal precoding vectors.

In example 24, which may also include one or more of the examples described herein, the fully coherent precoder is a rank 3 precoder and precoding vectors applied to the UL transmission comprise three orthogonal precoding vectors.

In example 25, which may also include one or more of the examples described herein, a number of precoding matrixes of orthogonal vectors and sets of orthogonal vectors, of the fully coherent precoder, increases in accordance with an oversampling factor associated with the UL transmission.

In example 26, which may also include one or more of the examples described herein, a base station may comprise a memory; and one or more processors configured to, when executing instructions stored in the memory, cause the base station to: receive, from a user equipment (UE), UE capability information; determine, based on the UE capability information, UE configuration information for a UL transmission using three antenna ports and a fully coherent precoder; communicate the UE configuration information to the UE; and receive, from the UE, a UL transmission using the three antenna ports.

In example 27, which may also include one or more of the examples described herein, the UE configuration information comprises a codebook that includes the fully coherent precoder.

In example 28, which may also include one or more of the examples described herein, the UE capability information comprises an oversampling factor corresponding to the UL transmission using the three antenna ports and the UE configuration information is determined based on the oversampling factor.

In example 29, which may also include one or more of the examples described herein, the UE capability information comprises an indication of the UE supporting fully coherent precoding for a linear array of three equally spaced antenna ports.

In example 30, which may also include one or more of the examples described herein, the UE capability information comprises an indication of the UE supporting fully coherent precoding for non-linear array of three non-equally spaced antenna ports.

In example 31, which may also include one or more of the examples described herein, a baseband processor, comprising: one or more processors configured to: determine a fully coherent precoder for precoding a data stream for an uplink (UL) transmission using three antenna ports; precode the data stream according to the fully coherent precoder; and transmit, to a base station, the UL transmission using the three antenna ports.

In example 32, which may also include one or more of the examples described herein, a method, performed by a user equipment (UE), the method may comprise: determining a fully coherent precoder for precoding a data stream for an uplink (UL) transmission using three antenna ports; precoding the data stream according to the fully coherent precoder; and transmitting, to a base station, the UL transmission using the three antenna ports.

In example 33, which may also include one or more of the examples described herein, a user equipment (UE) may comprise: a memory; and one or more processors configured to, when executing instructions stored in the memory, cause the UE to: determine a non-coherent precoder for precoding a data stream for an uplink (UL) transmission using two antenna ports of three antenna ports; precode the data stream according to the non-coherent precoder; and transmit, to a base station, the UL transmission using the three antenna ports.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
determine a fully coherent precoder for precoding a data stream for an uplink (UL) transmission using three antenna ports;
precode the data stream according to the fully coherent precoder; and
transmit, to a base station using the three antenna ports, the UL transmission with the precoded data stream.

2. The UE of claim 1, wherein the three antenna ports comprise a linear array of equally spaced antennas.

3. The UE of claim 1, wherein precoding vectors of the fully coherent precoder are based on a number of antenna ports and an oversampling factor associated with the UL transmission.

4. The UE of claim 1, wherein the fully coherent precoders are constructed based on a number of antenna ports and a set of precoding vectors.

5. The UE of claim 4, wherein a precoder vector is represented by:
$${u}_{m} = [ \begin{matrix}1 \\ {e}^{j \frac{2 π m}{ON}} \\ {e}^{j \frac{2 π m ( N - 1 )}{ON}}\end{matrix} ]$$
where N is 3, O is an oversampling factor; m is the index of the precoding vector a value from 0 through ON−1, e is a base of a natural logarithm, π is a ratio of a circumference of a circle relative to a diameter of the circle, and j is the imaginary unit.

6. The UE of claim 4, wherein a precoder vector is represented by:
$${v}_{i , k} = [ \begin{matrix}1 \\ {ϕ}_{i} \\ {ϕ}_{k}\end{matrix} ] ,$$
where
$${ϕ}_{k} = {e}^{j \frac{2 π k}{ON}}$$
represents the phase offset between two antenna ports, N is 3, i or k may be 0, 1, . . . , ON−1, and O is an integer or value that determines a granularity of the phase offset.

7. The UE of claim 4, wherein a rank 1 precoder of the fully coherent precoders compromises a precoding vector from the set of the precoding vectors.

8. The UE of claim 4, wherein a rank 2 precoder of the fully coherent precoders compromises two orthogonal precoding vectors from the set of the precoding vectors.

9. The UE of claim 4, wherein a rank 3 precoder of the fully coherent precoders compromises three orthogonal precoding vectors from the set of the precoding vectors.

10. The UE of claim 1, wherein precoding vectors, of the fully coherent precoder, are based on a rank of the fully coherent precoder.

11. The UE of claim 1, wherein the fully coherent precoder comprises a rank 1 precoder and a precoding vector applied to the UL transmission comprises any precoding vector of the fully coherent precoder.

12. The UE of claim 1, wherein the fully coherent precoder is a rank 2 precoder and precoding vectors applied to the UL transmission comprise two orthogonal precoding vectors.

13. The UE of claim 1, wherein the fully coherent precoder is a rank 3 precoder and precoding vectors applied to the UL transmission comprise three orthogonal precoding vectors.

14. The UE of claim 1, wherein a number of precoding matrixes, of the fully coherent precoder, increases in accordance with an increase of an oversampling factor associated with the UL transmission.

15. The UE of claim 1, wherein precoding vectors applied to the UL transmission is represented by:
$${u}_{m} = [ \begin{matrix}1 & {e}^{j \frac{2 π m}{ON}} & {e}^{j \frac{2 π m ( N - 1 )}{ON}}\end{matrix} ] ,$$
where, N is 3, O is an oversampling factor; m is a value from 0 through ON−1, e is a base of a natural logarithm, π is a ratio of a circumference of a circle relative to a diameter of the circle, and j is an imaginary unit.

16. The UE of claim 1, wherein a scaler is applied to precoders of the UL transmission to normalize transmit power.

17. A base station, comprising:
a memory; and
one or more processors configured to, when executing instructions stored in the memory, cause the base station to:
receive, from a user equipment (UE), UE capability information;
determine, based on the UE capability information, UE configuration information for a UL transmission using three antenna ports and a fully coherent precoder;
communicate the UE configuration information to the UE; and
receive, from the UE using the three antenna ports, the UL transmission with the precoded data stream.

18. The base station of claim 17, wherein the UE configuration information comprises a codebook that includes the fully coherent precoder.

19. A baseband processor, comprising:
one or more processors configured to:
determine a fully coherent precoder for precoding a data stream for an uplink (UL) transmission using three antenna ports;
precode the data stream according to the fully coherent precoder; and
generate, for transmission using the three antenna ports to a base station, the UL transmission with the precoded data stream.

20. The baseband processor of claim 19. wherein precoding vectors of the fully coherent precoder are based on a number of antenna ports and an oversampling factor associated with the UL transmission.
